(19) United States
(12) Patent Application Publication
(10) Pub. No.: US 2025/0389813 A1
(43) Pub. Date: Dec. 25, 2025

(54) MARINE RADAR COVERAGE VERIFICATION

(71) Applicant: CONOCOPHILLIPS COMPANY, Houston, TX (US)

(72) Inventors: Lars Christian Bahr, Houston, TX (US); Freddy Brakestad, Houston, TX (US)

(21) Appl. No.: 19/247,402

(22) Filed: Jun. 24, 2025

Related U.S. Application Data
(60) Provisional application No. 63/663,382, filed on Jun. 24, 2024.

(51) Int. Cl. G01S 7/40; G01S 13/91

(52) U.S. Cl. CPC G01S 7/40; G01S 13/917

(57) ABSTRACT

The invention relates to a vessel collision monitoring system that automatically and continuously compares radar and AIS observations over time. The movement of all (or many) vessels (12, 14) in the area (5) around an offshore installation (1) can be monitored and this data can be recorded and used to produce trends and reports indicating where there is a discrepancy between AIS “targets” and radar observations. In this way, potential blind spots (10) in the radar system can be identified and appropriate action taken, e.g. maintenance of the radar system (2) or moving or adding radar transmitters or receivers to remove a blind spot.

### CROSS-REFERENCE TO RELATED APPLICATIONS

This application is a non-provisional application which claims benefit under 35 USC § 119(e) to U.S. Provisional Application Ser. No. 63/663,382 filed Jun. 24, 2024 entitled “MARINE RADAR COVERAGE VERIFICATION,” which is incorporated herein in its entirety.

### STATEMENT REGARDING FEDERALLY SPONSORED RESEARCH OR DEVELOPMENT

None.

### FIELD OF THE INVENTION

This invention relates to a system and method for verifying the coverage of a marine radar system.

### BACKGROUND OF THE INVENTION

Offshore installations such as oil and gas platforms or windfarms and coastal installations such as terminals or ports may employ radar systems for monitoring their surroundings for vessels that may present a potential hazard. An aim of these systems is to detect vessels that may be on a collision course with the installation or present a security risk (intrusion).

In addition to radar, the digital system known as Automatic Identification System (AIS) may be used. The AIS system is based on the concept that all civilian vessels over a certain displacement are required to carry an automatic transponder that transmits a vessel's name and GPS position, and the offshore or coastal installation may have radio equipment that receives this information.

AIS is normally a secondary system, primarily for operational use. Since it can be switched off/disabled at the vessels, or the GPS data to the system can be manipulated, this is not normally considered an alternative or substitute for a radar-based system.

As the radar system is a safety critical system, at least in some jurisdictions there is a legal requirement to monitor the performance of the system, including detection of any blind spots, etc. This is done by periodically sailing a vessel on a predetermined course around the offshore installation and manually comparing radar and AIS data.

This operation is time-consuming and expensive. Since the vessel needs to be of a certain size to be similar to the types of vessel that would pose a risk to the integrity of the installation, the running costs for the vessel are significant. Furthermore, the vessel is occupied for some time and not available for other work.

Another problem with the current system is that it gives a performance status only at the time of a test. Any degradation of blind spots occurring in between tests might not be picked up before next test. Test results can be dependent on the weather conditions.

### BRIEF SUMMARY OF THE DISCLOSURE

In an embodiment of the invention, a method is provided for testing and/or verifying coverage and/or lack of coverage of a marine radar monitoring system on an offshore or coastal installation for monitoring the position and/or movement of vessels around the installation, wherein the radar monitoring system comprises at least one radar transmitter and at least one radar receiver located on the installation, and wherein the method comprises:
a) using at least one radar transmitter and receiver located on the installation to detect the presence of vessels in the vicinity of the installation;
b) using an AIS receiver located on the installation to receive AIS signals, including GPS data, from vessels in the vicinity of the installation;
c) passing information from the radar receiver and AIS receiver to a computer control unit programmed with monitoring software; and
d) by means of the control unit and software, automatically comparing information from the radar unit and AIS receiver and thereby determining the existence and/or location of potential blind spots in the coverage of the radar monitoring system or determining if a vessel does not have an operating AIS system.

More than one vessel may be monitored and AIS and radar data may be collected over time and a database created. The database may be used to determine or to refine information about the presence of blind spots in the coverage of the radar monitoring system. The database may be used to determine fluctuations in the coverage of the radar system over time. Data about weather may be collected and added to the database. The data about weather may be correlated to the presence or absence of radar blind spots.

The method may involve continuously or periodically automatically updating information about potential blind spots in the radar monitoring system.

The location of a vessel may be indicated by GPS data but no information about the location of the vessel may be available from radar; in this event the existence of a potential radar blind spot may be flagged. When the location of a vessel as indicated by GPS is outside an expected area of coverage by the radar system, a radar blind spot may not be flagged.

In another embodiment, a method is provided for testing and/or verifying coverage and/or lack of coverage of a marine radar monitoring system on an offshore or coastal installation for monitoring the position and/or movement of vessels around the installation, wherein the radar monitoring system comprises at least one radar transmitter and at least one radar receiver located on the installation, and wherein the method comprises:
a) using at least one radar transmitter and receiver located on the installation to detect the presence of vessels in the vicinity of the installation;
b) using an AIS receiver located on the installation to receive AIS signals, including GPS data, from vessels in the vicinity of the installation;
c) passing information from the radar receiver and AIS receiver to a computer control unit programmed with monitoring software;
d) building a database of accumulated information from the radar receiver and accumulated GPS data from the AIS signals for a plurality of vessel voyages and either (i) automatically comparing the radar information and GPS information to establish areas where GPS but not radar information is available or (ii) displaying the accumulated data in graphical form such that areas where there is no radar information are apparent to a user.

Any of these methods may include the step of checking the radar monitoring system when a potential blind spot is flagged and, if necessary, performing maintenance on the radar monitoring system. For example, the method may include the step of relocating one or more radar transmitters or receivers of the marine radar monitoring system in response to a radar blind spot being determined to exist, or alternatively adding one or more radar transmitters to the marine radar monitoring system.

The vessels whose presence is detected by radar information and AIS information need not be making a voyage specifically for the purpose of verifying the marine radar monitoring system.

Monitoring the position and/or movement of vessels may be conducted over a period of at least 1 month. The position and/or movement of at least 10 vessels may be monitored in the said one month period.

The installation may be a hydrocarbon producing platform or hydrocarbon drilling rig.

In another embodiment, a system is provided for analysing coverage and/or lack of coverage of a marine radar monitoring system for monitoring the position and/or movement of vessels around an offshore or coastal installation, wherein the system comprises:
a) at least one radar unit comprising a transmitter and receiver located on the installation;
b) an AIS receiver located on the installation for receiving AIS signals, including GPS data, from vessels in the vicinity of the installation;
c) a control unit arranged to receive information from the radar unit, the control unit including software for comparing information from the radar unit and AIS receiver;
d) wherein said control unit and software includes the functionality to monitor vessel traffic in the vicinity of the installation and determine the existence and/or location of potential blind spots in the coverage of the radar unit based on information from the AIS receiver.

The system may include a facility to receive weather information. The system may also include a database facility for storing AIS and radar data over time.

The idea concerns having a software function that automatically and continuously compares Radar and AIS observations over time. The movement of all (or many) vessels in the area can be monitored and this data can be recorded and used to produce trends and reports indicating where there is a discrepancy between AIS “Targets” and Radar observations. This could be directly transferable to a coverage report with little or no manual effort or use of dedicated vessels. These reports could be used to monitor performance changes over time and pick up degradation of the system of other hidden faults. There may be no need to sail vessels specifically to test radar coverage, thus potentially eliminating this cost. The system could also be used to detect vessels that have their AIS switched off, which could flag potential risk from the vessel.

The invention has been devised in the context of offshore oil and gas platforms, but is equally applicable to any offshore structure or installation such as a wind farm, accommodation platform, drilling rig, etc. and also to coastal structures or installations such as a port or harbor or a terminal. The invention could apply in any coastal or offshore situation where there may be a risk of collision from a vessel.

Examples and various features and advantageous details thereof are explained more fully with reference to the exemplary, and therefore non-limiting, examples illustrated in the accompanying drawings and detailed in the following description. Descriptions of known starting materials and processes can be omitted so as not to unnecessarily obscure the disclosure in detail. It should be understood, however, that the detailed description and the specific examples, while indicating the preferred examples, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but can include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term substantially, as used herein, is defined to be essentially conforming to the particular dimension, shape or other word that substantially modifies, such that the component need not be exact. For example, substantially cylindrical means that the object resembles a cylinder, but can have one or more deviations from a true cylinder.

Additionally, any examples or illustrations given herein are not to be regarded in any way as restrictions on, limits to, or express definitions of, any term or terms with which they are utilized. Instead these examples or illustrations are to be regarded as being described with respect to one particular example and as illustrative only. Those of ordinary skill in the art will appreciate that any term or terms with which these examples or illustrations are utilized encompass other examples as well as implementations and adaptations thereof which can or cannot be given therewith or elsewhere in the specification and all such examples are intended to be included within the scope of that term or terms. Language designating such non-limiting examples and illustrations includes, but is not limited to: “for example,” “for instance,” “e.g.,” “In some examples,” and the like.

Although the terms first, second, etc. can be used herein to describe various elements, components, regions, layers and/or sections, these elements, components, regions, layers and/or sections should not be limited by these terms. These terms are only used to distinguish one element, component, region, layer or section from another. Thus, a first element, component, region, layer or section discussed below could be termed a second element, component, region, layer or section without departing from the teachings of the present inventive concept.

An example device suitable for implementing one or more aspects of the present disclosure includes a central processing unit (CPU), interfaces, and a connection (e.g., a PCI bus). When acting under the control of appropriate software and/or firmware, the CPU is responsible for executing packet management, error detection, and/or routing functions. The CPU preferably accomplishes all these functions under the control of software including an operating system and any appropriate applications software. CPU may include one or more processors, such as a processor from the INTEL X86 family of microprocessors. In some cases, processor can be specially designed hardware for controlling the operations of the device. In some cases, a memory (e.g., non-volatile RAM, ROM, etc.) also forms part of the CPU. However, there are many different ways in which memory could be coupled to the system.

The interfaces are typically provided as modular interface cards (sometimes referred to as “line cards”). Generally, they control the sending and receiving of data packets and sometimes support other peripherals used with the device. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master microprocessor (e.g. CPU) to efficiently perform routing computations, network diagnostics, security functions, etc.

Although the system described is one specific device according to some examples of the present technologies, it is by no means the only network device architecture on which the present technologies can be implemented. For example, an architecture having a single processor that handles communications as well as routing computations, etc., is often used. Further, other types of interfaces and media could also be used with the device.

Regardless of the device's configuration, it may employ one or more memories or memory modules (including memory) configured to store program instructions for the general-purpose operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory could also hold various software containers and virtualized execution environments and data.

The device can also include an application-specific integrated circuit (ASIC), which can be configured to perform routing and/or switching operations. The ASIC can communicate with other components in the device via the connection, to exchange data and signals and coordinate various types of operations by the device, such as routing, switching, and/or data storage operations, for example.

A computing system architecture comprises components in electrical communication with each other using a connection such as a bus. A exemplary system includes a processing unit (CPU or processor) and a system connection that couples various system components including the system memory, such as read only memory (ROM) and random access memory (RAM), to the processor. The system can include a cache of high-speed memory connected directly with, in close proximity to, or integrated as part of the processor. The system can copy data from the memory and/or the storage device to the cache for quick access by the processor. In this way, the cache can provide a performance boost that avoids processor delays while waiting for data. These and other modules can control or be configured to control the processor to perform various actions. Other system memory may be available for use as well. The memory can include multiple different types of memory with different performance characteristics. The processor can include any general purpose processor and a hardware or software service, such as service 1, service 2, and service 3 stored in storage device, configured to control the processor as well as a special-purpose processor where software instructions are incorporated into the actual processor design. The processor may be a completely self-contained computing system, containing multiple cores or processors, a bus, memory controller, cache, etc. A multi-core processor may be symmetric or asymmetric.

To enable user interaction with the computing system architecture, an input device can represent any number of input mechanisms, such as a microphone for speech, a touch-sensitive screen for gesture or graphical input, keyboard, mouse, motion input, speech and so forth. An output device can also be one or more of a number of output mechanisms known to those of skill in the art. In some instances, multimodal systems can enable a user to provide multiple types of input to communicate with the computing system architecture. The communications interface can generally govern and manage the user input and system output. There is no restriction on operating on any particular hardware arrangement and therefore the basic features here may easily be substituted for improved hardware or firmware arrangements as they are developed.

Storage device is a non-volatile memory and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and hybrids thereof.

The storage device can include services for controlling the processor. Other hardware or software modules are contemplated. The storage device can be connected to the system connection. In one aspect, a hardware module that performs a particular function can include the software component stored in a computer-readable medium in connection with the necessary hardware components, such as the processor, connection, output device, and so forth, to carry out the function.

While preferred examples of the present inventive concept have been shown and described herein, it will be obvious to those skilled in the art that such examples are provided by way of example only. Numerous variations, changes, and substitutions will now occur to those skilled in the art without departing from the disclosure. It should be understood that various alternatives to the examples of the disclosure described herein can be employed in practicing the disclosure. It is intended that the following claims define the scope of the disclosure and that methods and structures within the scope of these claims and their equivalents be covered thereby.

### BRIEF DESCRIPTION OF DRAWINGS

A more complete understanding of the present invention and benefits thereof may be acquired by referring to the follow description taken in conjunction with the accompanying drawings in which:

FIG. 1 is a schematic plan view of an offshore hydrocarbon producing platform, radar system and marine traffic; and

FIG. 2 is a flow chart showing steps of an exemplary method according to the invention.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

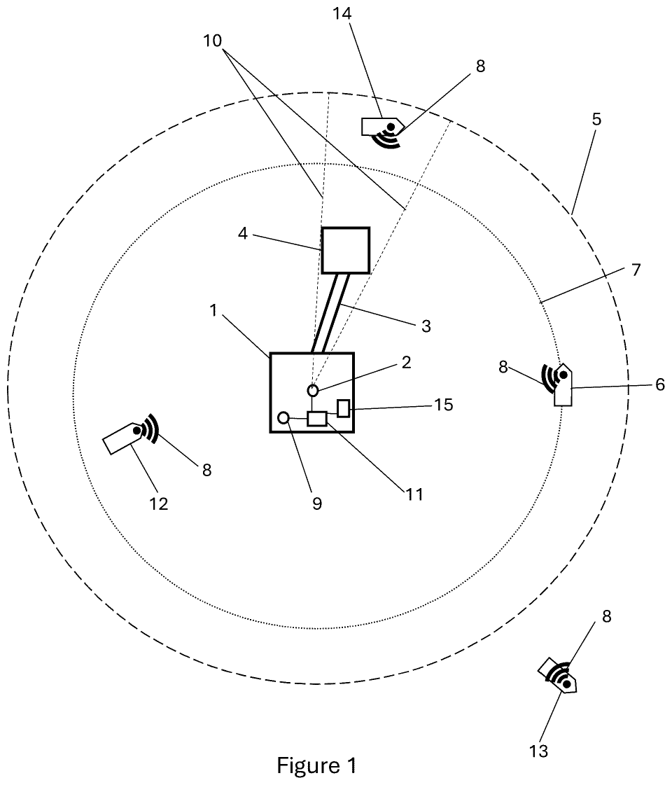

FIG. 1 shows in highly schematic form an offshore hydrocarbon producing platform 1, equipped with a radar monitoring system 2. The system 2 comprises at least one radar transmitter and receiver and ancillary equipment, the details of which are conventional and have been omitted from the drawing for clarity. The platform 1 is connected by a bridge 3 to a smaller secondary platform 4. Dashed line 5 indicates the nominal range of the radar system 2.

The radar system is required in order to identify marine vessels that may potentially pose a risk to the platform and associated installations by inadvertently, or even intentionally, colliding with the structure of the platform or associated installations.

It is necessary periodically to test the radar system to establish any blind spots in the coverage of the radar system. The established way of doing this is to sail a vessel on a chosen route around the platform and associated installations. This is represented in FIG. 1 by the vessel 6 whose route is represented by the dotted line 7. The route 7 is entirely within the range of the radar system as indicated by the dashed line 5.

The vessel 6 is equipped with a standard AIS system, in common with any marine vessel of significant size. The AIS system is represented schematically and indicated by reference numeral 8; the system includes a GPS location facility and continuously transmits a radio signal indicating the identity of the vessel and its position. The AIS system is conventional and therefore the elements of the system are not represented individually. The platform is equipped with a radio receiver 9 for receiving AIS signals from the vessel 8 and any other vessels.

As the vessel 6 navigates its predetermined course 7 around the platform 1, the radar system 2 is used to monitor its position. At the same time the AIS signal from the vessel 6 is monitored. If at any time the radar signal disappears, this flags the existence of a potential blind spot in the radar system. The position of the vessel can normally still be established using the AIS system and the potential blind spot mapped.

FIG. 1 shows a potential radar blind spot caused by the “shadow” of the secondary platform 4. The blind spot is bounded by dashed lines 10. If a blind spot is noted, then remedial action may be taken. This can involve checking if the radar system requires maintenance, relocating the transmitter or receiver to remove the blind spot or adding a further radar transmitter or receiver.

This method of establishing radar blind spots has a number of problems. It is expensive to charter a relatively large vessel for the sole purpose of sailing a course to check the radar on an offshore installation. The size of vessel needed is governed by the monitoring requirements in different jurisdictions, but commonly a hull length of more than 40 meters is necessary. Partly for this reason, checks on radar systems are performed relatively infrequently-perhaps only once every few years. In the intervening time, blind spots may come into being e.g. due to new structures being installed, and the blind spots are not logged until the next check is made. The radar system may deteriorate and this may not be picked up until the next check. Radar coverage can be weather dependent and blind spots may sometimes only come into existence in poor weather conditions, or the overall range of the system may be affected by weather. If the procedure to check for blind spots is carried out in fair weather then a blind spot that only exists in poor weather may be missed.

The invention is intended to mitigate one or more of these problems. In the embodiment illustrated schematically in FIG. 1, the radar system 2 and AIS radio receiver 9 are each connected to a computer tracking and monitoring system 11. The monitoring system 11 continuously receives information from radar and AIS and automatically compares them and correlates the information so that a vessel identified by radar is also identified automatically using AIS.

In this way, any vessel of significant size and emitting an AIS signal that happens to be within radar range of the platform 1 is tracked automatically. Over time, a database of information about the courses the vessels have sailed is built up and blind spots in the radar coverage will show up.

Since the system is functioning continuously, there is normally much less of a time lag between a blind spot coming into existence and being flagged. It should be possible to identify blind spots that only come into existence in poor weather. Weather information can be incorporated into the database, so that information about the conditions in which certain blind spots occur can be noted.

In this system there is no need to charter a vessel for the sole purpose of sailing a course around the platform to check for radar blind spots, thereby saving considerable expense. Although an individual vessel on other business navigating through the radar coverage area of the platform is unlikely on its own to enable a complete assessment of radar blind spots, if every vessel entering the radar coverage area is monitored automatically then complete information about blind spots will be built up over time. Furthermore, the information will be constantly updated and should allow blind spots that only occur in poor weather, or variations in radar range that occur in poor weather, to be noted.

FIG. 1 shows three vessels 12, 13, 14 that have sailed near the platform on business other than specifically to monitor radar coverage. All have AIS systems 8 as is conventional. Vessel 12 is within the nominal range 5 of the radar system 2. It is transmitting an AIS signal that is received by the receiver 9 on the platform 1. The radar system 2 also registers the vessel's position and information from AIS receiver and radar system is fed to the monitoring system 11 where the two sources of information are correlated and logged as relating to a particular vessel. The vessel is continuously tracked and data about its position continuously logged and recorded in a database. Provided both radar and AIS signals are received, no flag is raised about potential radar blind spots.

Vessel 13 is outside the nominal range 5 of the radar system 2. The radar system 2 does not register the existence of the vessel. The AIS system has longer range and the AIS receiver receives a signal from the vessel and this information is fed to the monitoring system 11. The monitoring system 11 notes that the position of the vessel 13 is outside radar range and therefore does not flag the existence of a potential radar blind spot.

Vessel 14 is within radar range 5. However, it also lies in a radar shadow as indicated by dashed lines 10. An AIS signal is received from the vessel but a radar signal is not. The monitoring system notes that, according to the GPS position data in the AIS signal, the vessel 14 is in radar range but no radar signal is being received, so a potential radar blind spot is flagged. As the vessel continues on its course, it may emerge from the radar blind spot in which case the monitoring system will start to receive radar information and at this time the vessel's position will be noted as being a point on the boundary of the potential blind spot.

As many vessels sail through the blind spot, information about the boundaries of the blind spot may be built up over time. In this way the extent and location of a blind spot may be determined with more precision than by the current system of deliberately sailing a vessel on a single voyage to check for blind spots.

A weather monitoring station 15 is installed on the platform. The station 15 includes standard equipment for monitoring weather including rainfall, fog, temperature, etc. The details of the station are omitted for clarity but are conventional in themselves. The weather monitoring station 15 is connected to the monitoring system 11 and provides a continuous feed of weather information to the monitoring system 11. The monitoring system is able to correlate weather conditions to the results of any analysis of AIS and radar signals.

The monitoring system may also be used to check if a vessel's AIS system is working correctly or, for example, if GPS position data has been disabled or has been manipulated. For example, if a vessel is showing up on radar but there is no corresponding AIS signal then the system could flag the presence of a vessel whose AIS or GPS has been disabled.

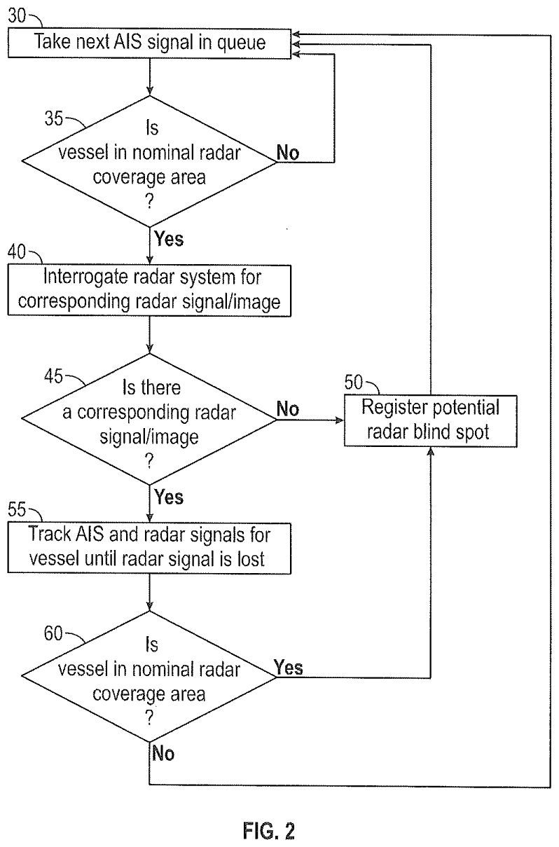

The way in which the system analyses received AIS, radar and/or weather data and provides information to a user may vary without departing from the scope of the invention. FIG. 2 shows a one basic sequence of logic for analyzing AIS and radar data for a given vessel. The system may carry out the same sequence of steps for multiple vessels simultaneously if necessary.

AIS signals may be picked up by a base station on a hydrocarbon producing platform, for example, from as far as 100 kilometers This is greater the range of the vessel monitoring radar in normal use on a hydrocarbon production platform. The logic sequence shown in FIG. 2 is therefore initiated in step 30 by the monitoring system first receiving an AIS signal from the AIS receiver, including GPS information, from a vessel. The sequence then makes a comparison at step 35 between the position indicated by the GPS component of the AIS signal and a stored value representing the nominal range of the radar system. If the comparison indicates that the vessel is outside nominal radar range, then the logic returns to the start. At any one time there is likely to be more than one vessel within range of the AIS receiver so step 30 may include a queueing system whereby AIS signals are detected and fed to step 35 in order. If an AIS signal is analyzed and found to be outside radar range then it is returned to the back of the queue to be re-analyzed at a future time when the vessel associated with the signal may have entered radar range.

If an AIS signal is found at step 35 to include GPS data that places the vessel in nominal radar range, then the sequence progresses to step 40, which is to interrogate the received data from the radar system. Step 45 is a comparison of the radar data with the particular piece of AIS GPS information being analyzed to establish whether there is a radar signal that places a vessel in the same position as the AIS signal. If no corresponding radar signal can be located in the data from the radar system, then the logic sequence flags a potential blind spot at step 50. The logic then returns to the start 30 where it looks for the next AIS signal in the queue.

If at step 45 a corresponding radar signal is detected, then the monitoring system locks on to the AIS and radar signals identified as being related to the same vessel and tracks the signals as the vessel moves until the point where the radar signal is lost (step 55). At that point the sequence moves to a decision point at 60; if the vessel position as shown by the AIS signal is within the nominal radar range, then a potential blind spot is registered (box 50) and then the sequence returns to the start 30. If the vessel is not shown by the AIS data to be in nominal radar range, then the sequence just returns directly to the start 30. As AIS signals are analyzed one by one from the queue (box 30), if this vessel re-merges from a radar blind spot, then it will be picked up again on radar and tracked again (step 55). The AIS signal contains information about vessel identity and it may therefore be possible for the monitoring system to correlate the new data with the old for this vessel, but for the purposes only of establishing the location and extent of radar blind spots that may not be necessary.

If every time a blind spot is registered this is recorded in a database, then this logic sequence should result in boundaries of blind areas being mapped.

Alternatively, if in step 55 the vessel is tracked using AIS alone, then this may provide data points within the radar blind area as opposed to plotting only the boundaries.

It will be appreciated that there are many other possible ways of analyzing and processing data from the AIS and radar systems. For example, another approach is to record all AIS and radar position data from any vessel in radar range, either as vessel routes or simply as points. This data could then be analyzed for “holes” where there is AIS data but no radar data. This could be done automatically and potential blind spots flagged by the system. Alternatively or in addition, the analysis could involve plotting a chart showing the vessel routes as shown by AIS and radar, or plotting data points from the radar and AIS systems. Such a chart may be a simple way of visually highlighting blind spots to a user of the system. The plotted points could distinguish, e.g. by color coding, whether a radar signal only, an AIS signal only, or radar and AIS signals have been identified for a given vessel at a given position.

The AIS/radar data set could be paired with data from other sources such as weather and create a sub set of data for periods with a particular weather type, such as wave height above a set threshold, or heavy snow etc. to demonstrate the ability to identify radar targets in particular weather conditions. To create this data for different weather conditions could otherwise only be gathered by a testing the system with sailings in various weather conditions.

The AIS data message may contain rudimentary information about the size of the vessel. This information (in addition to the vessel name and ID) could be used to refine the comparisons. Vessels of a certain size may only need to be monitored for a given distance. For example, smaller fishing vessels are obligated to carry AIS equipment, but there is no requirement to detect them on radar outside a 12 nautical mile radius. Larger vessels need to be detected at 20 nautical miles.

The coding discussed above could therefore also distinguish different size vessels that may present different levels of risk and may have different legal requirements for monitoring, e.g. range.

Where multiple radar systems are in operation, coding could be used to represent which radar system or systems have picked up the vessel.

By plotting each monitored sailing with position markers/dots for instance every 30 or 60 seconds, with different color for Radar+AIS, Radar Only and AIS Only, it would be possible to create a coverage map over time. The radar coverage area is a full circle and based on the AIS data (length of hull, beam) it should also be possible to train an artificial intelligence based system to sort out vessels that should be registered on 20 nautical miles, and vessels that should be registered on 12 nautical miles. The 20 nautical miles range applies to large vessels with hull length more than 40 meters; the 12 nautical miles range applies to small vessels with hull length from 1 to 40 meters. The result would improve with time, and the data could be reset after implementing compensating measures, to verify that the measures work.

Example coding systems may include the following.
NO COLOR: RADAR+AIS—LARGE VESSEL,
Color 1: RADAR ONLY—LARGE VESSEL,
Color 2: AIS ONLY—LARGE VESSEL
NO COLOR: RADAR+AIS—SMALL VESSEL,
Color 3: RADAR ONLY—SMALL VESSEL,
Color 4: AIS ONLY—SMALL VESSEL

In situations with overlapping radar systems, the information could also be divided into Color 1—Radar 1, Color 2—Radar 1, Color 3—Radar 2, Color 4—Radar 2, Color 5—both Radar 1 and Radar 2, Color 6—both Radar 1 and Radar 2, and so on. Color selection may be used to denote vessel size, radar, AIS, proximity, direction, other vessel properties, or a combination thereof.

In situations where both Radar+AIS is missing during sailing, an AI system could pair the information gathered before losing the information with the information picked up when vessel is back under surveillance to predict the area where no Radar+AIS was gathered.
ENTER AREA
(AIS+RADAR)
AIS ONLY or RADAR ONLY
NO INFO RECEIVED
AIS ONLY or RADAR ONLY
(RADAR+AIS)
LEAVING AREA.

This would over time draw sectors indicating potential blind spots, and by including the possibility to extract reports from the system (either automatically on a schedule or by request) it should be possible to show the detection quality for each radar site, divided into the different sensors.

Each monitored sailing could draw a line through the radar detection area, slowly building up the information about blind spots for both radar and AIS coverage.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method for testing and verifying coverage and/or testing performance of a marine radar monitoring system on an offshore or coastal installation for monitoring the position and movement of vessels around the installation, wherein the radar monitoring system comprises at least one radar transmitter and at least one radar receiver located on the installation, and wherein the method comprises:
a) using at least one radar transmitter and receiver located on the installation to detect the presence of vessels in the vicinity of the installation;
b) using an Automatic Identification System (AIS) receiver located on the installation to receive AIS signals, including GPS data, from vessels in the vicinity of the installation;
c) passing information from the radar receiver and AIS receiver to a computer control unit programmed with monitoring software; and
d) automatically comparing information from the radar unit and AIS receiver with the control unit and software, thereby determining the existence of potential blind spots in the coverage of the radar monitoring system, the location of blind spots in the coverage of the radar monitoring system, determining potential faults or inadequacies in the radar monitoring system, determining if a vessel does not have an operating AIS system, or combinations thereof.

2. The method according to claim 1, wherein more than one vessel is monitored and wherein AIS and radar data is collected over time and a database created.

3. The method according to claim 2, wherein the database is used to determine or to refine information about the presence of blind spots in the coverage of the radar monitoring system.

4. The method according to claim 2, wherein the database is used to determine fluctuations in the coverage of the radar system over time.

5. The method according to claims 2, wherein data about weather is collected and added to the database.

6. The method according to claim 5, wherein data about weather is correlated to the presence or absence of radar blind spots.

7. The method according to claim 1, comprising continuously or periodically automatically updating information about potential blind spots in the radar monitoring system.

8. The method according to claim 1, wherein when the location of a vessel is indicated by GPS data but no information about the location of the vessel is available from radar, the existence of a potential radar blind spot is flagged.

9. The method according to claim 8, wherein when the location of a vessel as indicated by GPS is outside an expected area of coverage by the radar system, a radar blind spot is not flagged.

10. A method for testing coverage and/or performance of a marine radar monitoring system on an offshore or coastal installation for monitoring the position and movement of vessels around the installation, wherein the radar monitoring system comprises at least one radar transmitter and at least one radar receiver located on the installation, and wherein the method comprises:
a) using at least one radar transmitter and receiver located on the installation to detect the presence of vessels in the vicinity of the installation;
b) using an Automatic Identification System (AIS) receiver located on the installation to receive AIS signals, including GPS data, from vessels in the vicinity of the installation;
c) passing information from the radar receiver and AIS receiver to a computer control unit programmed with monitoring software;
d) building a database of accumulated information from the radar receiver and accumulated GPS data from the AIS signals for a plurality of vessel voyages; and
e)
(i) automatically comparing the radar information and GPS information to establish areas where GPS but not radar information is available; and/or
(ii) displaying the accumulated data in graphical form such that areas where there is limited or no radar information are apparent to a user.

11. The method according to claim 10, including the step of checking the radar monitoring system when a potential blind spot is flagged and, if necessary, performing maintenance on the radar monitoring system.

12. The method according to claim 10, including the step of relocating one or more radar transmitters or receivers of the marine radar monitoring system in response to a radar blind spot being determined to exist.

13. The method according to claim 10, including the step of adding one or more radar transmitters or receivers to the marine radar monitoring system in response to a radar blind spot being determined to exist.

14. The method according to claim 10, wherein the vessels whose presence is detected by radar information and AIS information are not making a voyage specifically for the purpose of verifying the marine radar monitoring system.

15. The method according to claim 10, wherein monitoring the position and/or movement of vessels is conducted over a period of at least 1 month.

16. The method according to claim 15, wherein the position and/or movement of at least 10 vessels is monitored in the said one month period.

17. The method according to claim 10, wherein the offshore installation is a hydrocarbon producing platform or hydrocarbon drilling rig.

18. A system for analyzing coverage of a marine radar monitoring system for monitoring the position and movement of vessels around an offshore or coastal installation, wherein the system comprises:
a) at least one radar unit comprising a transmitter and receiver located on the installation;
b) an Automatic Identification System (AIS) receiver located on the installation for receiving AIS signals, including GPS data, from vessels in the vicinity of the installation; and
c) a control unit arranged to receive information from the radar unit and the AIS receiver, the control unit including software for comparing information from the radar unit and AIS receiver;
wherein said control unit and software includes the functionality to monitor vessel traffic in the vicinity of the installation and determine the existence and/or location of potential blind spots in the coverage of the radar unit based on information from the AIS receiver.

19. The system according to claim 18, wherein the system also includes a facility to receive weather information.

20. The system according to claim 18, wherein the system includes a database facility for storing AIS and radar data over time.
